(19) United States
(12) Patent Application Publication
(10) Pub. No.: US 2011/0246580 A1
(43) Pub. Date: Oct. 6, 2011

(54) Method And Apparatus For Electronic Mail Management

(75) Inventors: Stuart O. Goldman, Scottsdale, AZ (US); Richard Krock, Naperville, IL (US)

(73) Assignee: Alcatel-Lucent USA Inc., Murray Hill, NJ (US)

(21) Appl. No.: 12/750,114

(22) Filed: Mar. 30, 2010

(51) Int. Cl. G06F 15/16

(52) U.S. Cl. 709/206

(57) ABSTRACT

A system and method for email management. An automatic reply control table is provided, and an entry may be created based on a designation made by a user when composing an email for transmission. An email manager then monitors incoming email to determine whether a particular email includes an indicator that it is an automatic-reply message and, if so, whether it corresponds to an entry on the automatic reply control table. If it does, then the received automatic reply message is deleted or otherwise disposed of. A notification may be generated for presentation to the sender of the original email indicating the disposition of received automatic reply messages corresponding to a particular transmitted email.

### TECHNICAL FIELD

The present invention relates generally to the field of communications via computer networks, and, more particularly, to a method and apparatus device for selective handling the receipt of automatic-replies such as “out-of-office” messages.

### BACKGROUND

Electronic mail, or email, is a communication system commonly associated with computer networks. A computer is an electronic computing machine. A computer network is a collection of computing devices that are interconnected in such as way as to permit the sharing of computing resources and data storage. Computer networks began as a way to tie together computers in a single department, building, or campus, but now the concept of computer networking has been expanded. The Internet and commercial carrier networks, for example, permit computers that are separated by large distances and owned by different entities to communicate with each other.

Once computers began communicating with each other, computer users quickly began using the networks to communicate with other users as well. Sophisticated computer users soon figured out how to send simple, and then longer text messages to each other over the networks. File transfer procedures were also worked out so that users could transmit large files to each other. Some of these procedures may have been difficult for people outside of the industry to understand and use, but for the most part their use was for a time limited to computer professionals.

Once computers became a common tool for others, even for those not involved in science and engineering professions, it because necessary to develop user-interfaces that made using the computers quicker to master. This was made easier, in part, by graphic user interfaces, but was also aided by thoughtfully-crafted applications that made using computers more intuitive. Although this was true for many other computer applications, these improvements made email very popular with almost every computer user at any level of sophistication.

In general, an electronic email system includes hardware and software components. A properly-configured computer allows a user to indicate an intended recipient or recipients and to enter text into a file. Upon entry of an appropriate command, the file is transformed into segments of transmissible data and sent out over the computer network. The transmitted data is of course properly addressed so that it will be sent to the correct entity. Presuming that the intended recipients also are equipped with properly-configured and compatible computers, the recipient computer transforms the data into a graphic display presenting the text entered by the sender.

Modern email has improved even further, so senders may transmit stylized text, pictures and other objects, and attached files to an email. These are also received and displayed, saved, or otherwise utilized by the recipient computer, typically upon entry of a command by the user.

As might be expected, email is a very popular business tool. Due to the speed of transmission, users can communicate messages back and forth with very little delay. This being the case, many users send emails with the expectation that they will be read and acted on promptly. Often, emails are used in lieu of telephone calls to set up meetings or resolve issues quickly. Unlike a telephone call, however, an email does not reveal immediately that the intended recipient is not located so as to be able to respond quickly. In some cases, it may be several days or longer before an addressee sees a transmitted email.

One solution to this issue is an “out-of-office” response. The out-of-office response is an automatic reply to a received email that carries a short message announcing or explaining the recipient user's absence. Although this type of automated reply may vary from one system to another, certain features are commonplace.

First, the out-of-office reply is naturally automatically sent, usually from an email server associated with the recipient—naturally, since its primary use is to announce the absence of the intended recipient user. In most cases, this automatic response can be turned on and off by a user, so that automatic replies only are sent when actually needed or desired. The automatic nature of the reply typically means that it is sent quickly, and hopefully soon received by the sender. The sender is then notified in time to take any additional action required. In addition, the out-of-office reply may provide a short explanation of the reason for the absence, alternate contact information, or the address of another person to contact.

Finally, the out-of-office message is a reply that almost universally uses the same subject matter reference, or subject line, as the message being replied to. This is natural as well, because in this way the sender can easily recognize the association between the automatic reply and the original email. In such cases, however an indication is typically added to the subject line of the automatic reply that it is an out-of-office or similar message.

As should be apparent, out-of office message and similar automatic replies are very useful in many cases. In others, however, they can be inconvenient. For example, when a sender is agnostic about whether an intended recipient is absent, the automatic reply is unnecessary. Perhaps the sender is already aware of the other's absence or the sender's message does not have to be acted on quickly (or at all). Or the email is a notice that is sent to a large number of recipients, and the status of any one of them is of little interest to the sender.

In any of these cases, the sender may receive a large number of out-of-office replies that, despite the face that they are of no use, still have to be individually selected or viewed and deleted. Most users prefer not to leave their “inbox” full of unnecessary emails. Not only is there an inconvenience involved, but the chances of missing a substantive reply or other important email increase.

One solution is to enable a user to set up “filters” to automatically re-route, file, or delete certain emails. If a filter could be arranged to delete any received message that contains the term “out-of-office” or a similar phrase, then the problem might be mitigated. There are a number of problems with this approach, however. First, filters are sometimes hard to set up, or to set up properly, at least for some users. In addition, filters apply their rules in strict and sometimes unexpected ways. Of course, the user may also forget to turn off or adjust the filter when a change is desired. And in many instances, some out-of-office replies are useful when others are not. The filter cannot easily make such fine distinctions, especially on a per message basis.

Accordingly, there has been and still is a need to address the aforementioned shortcomings and other shortcomings associated with automatic replies to sent email messages. These needs and other needs are satisfied by the present invention.

### SUMMARY

The present invention is directed to a manner of managing email messages. Specifically, the method and apparatus of the present invention provide a way to reduce or eliminate the burden associated with unnecessary or unwanted out-of-office and other automatic-reply messages.

In one aspect, the present invention is a method for managing automatic reply messages in an email system including creating an entry in an automatic-reply control table associated with a transmitted email if the transmitted email has been designated by a sender for automatic reply control, monitoring each email to the sender that is received to detect the presence of automatic reply indicators, determining whether a received email having an automatic reply indicator corresponds with an automatic reply control table entry, disposing of the email if it is determined to correspond with an automatic reply control table entry. Thus the sender can designate a particular email to be entered into the table while other emails being sent would not be so designated. The method may further include deleting entries in the automatic-reply control table after a pre-determined amount of time has passed since their initial entry into the table.

In another aspect, the present invention is a system for email management including an automatic-reply control table resident on a user email device such as a computer or on an email server through which the computer may transmit email for delivery. The system further includes an email manager for creating entries in the automatic reply control table, for monitoring emails received at the computer or the associated email server, or both, to determine whether the received emails include an indicator indicating that they are automatic-reply message and, if so, comparing the messages so indicated to entries on the automatic-reply control list. The email manager is also configured to delete or otherwise dispose of received automatic reply messages that are found to be replies to emails designated by the user.

Additional aspects of the invention will be set forth, in part, in the detailed description, figures and any claims which follow, and in part will be derived from the detailed description, or can be learned by practice of the invention. It is to be understood that both the foregoing general description and the following detailed description are explanatory rather than restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a schematic diagram illustrating a data communication network configured according to an embodiment of the present invention;

FIG. 2 is a flow diagram illustrating a method of managing automatic reply email messages according to an embodiment of the present invention; and

FIG. 3 is a flow diagram illustrating a method of managing automatic reply email messages according to another embodiment of the present invention.

### DETAILED DESCRIPTION

The present invention is directed to a manner of managing email messages. Specifically, the method and apparatus of the present invention provide a way to reduce or eliminate the burden associated with unnecessary or unwanted out-of-office and other automatic-reply messages. While the present invention will most advantageously be applied to popular and widely-used email applications such as Microsoft® Outlook®, it is meant to apply to any email system in which it may be implemented.

In general, the present invention may be implemented in an email system that allows users to compose and transmit email messages to other users through a data communication network. Note here that the term network is broadly intended, and includes internets, that is, networks of two or more computer networks, and the Internet. “Computer” should be understood in this disclosure to refer to any electronic device configured to and capable of (at least) communicating via a network for transmitting and receiving email. An email system includes a computer, as used in this sense, and an “email application”, which, as used herein, is a computer program, or set of instructions, that is incorporated into the computer to control operation of the email function. The email system may also include an email server, as explained in more detail below.

As mentioned above, it may be inconvenient, or worse, for a computer user to receive unnecessary or unwanted automatic-reply messages that indicate only that one or more, or perhaps many, of the intended recipients are out of the office. For example, a building manager may send an email on a holiday to alert returning workers of the need to exchange their parking cards for new ones by a date in the future. Most if not all of the employees are not in the office, and their email server returns a great many out-of-office reply messages. If some of the emails are undeliverable, perhaps because an email list is out of date, this may also generate many automatic-reply messages. Not only does the manager have to view or delete all of these, in the clutter an important, substantive reply may be overlooked or accidently deleted.

The present invention addresses this problem by allowing the sender, in this example the building manager, to easily manage the anticipated automatic reply messages. This solution will now be described in more detail, beginning with a description of an exemplary network in which the present invention may operate.

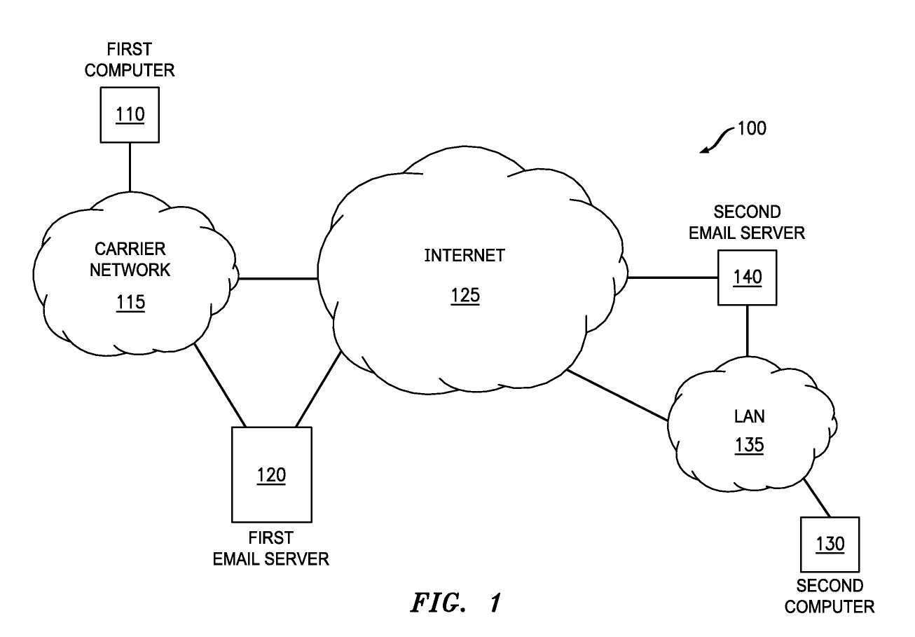

FIG. 1 is a simplified schematic diagram illustrating selected components of a network 100 in which the present invention may be advantageously implemented. Note here again that the term network is being used broadly; FIG. 1 is exemplary, and no specific network or configuration is required. In the embodiment of FIG. 1, a first computer 110 is available to a user to send and receive email. In addition, the first computer 110 is configured with both the hardware and email application to operate according to an embodiment of the present invention. In this embodiment, first computer 110 communicates with a carrier network 115, using for example a DSL (digital subscriber line) or PON (passive optical network) technology. Via the carrier network, first computer 110 can communicate with first email server 120.

In many implementations, an end user's computer such as first computer 110 is not powered up and connected to a network at all times. Attempts to deliver an email to a computer that is not linked to a network will of course be unsuccessful. For these and other reasons, many of the email functions are often incorporated into an email server. First email server 120 may receive and store email intended for the user of first computer 110, who may selectively connect to the server 120 via network 115 and download the email that is stored there. Any emails composed by the user of first computer 110 while it was “offline”, or not connected to network 115 and first email server 120, may also be uploaded to the server for transmission, for example through the Internet 125. Although transmission of uploaded emails from first email server will normally take place quickly, it may store these “sent” emails for a time in case the user wishes to retrieve and view them.

In many cases, the email server is owned by someone other than the user and, in fact, performs these email functions for a great many users that subscribe to this service. It is not unusual, therefore, for an email server to delete stored emails when they are downloaded, or after they have been stored for a certain period of time. While they remain stored on the email server, however, they may be available to the user through a Web site via a connection to the Internet. A user may access their email in this way, for example, if they are traveling and wish to view their email using a different computer. In this case, the user often simply views emails that may be downloaded to their computer at a later time, unless they are first deleted through the Web site by the user or discarded by the email server.

In the embodiment of FIG. 1, network 100 also includes a second computer 130. Second computer 130 is also configured to send and receive email messages. It may also be configured to manage email replies according to the present invention, although that is not required in all embodiments for operation of the present invention with respect to the first computer 110 or first email server 120. Second computer 130 in this embodiment is connected to a LAN (local area network) 135, and via LAN 135 with second email server 140. Being so connected, a user of second computer 130 may also send and receive email in a fashion similar to that described above in reverence to the user of first computer 110.

Note again that this illustration of network 100 is exemplary and not limiting, and many variations are possible. In almost all cases, there will be many more computers connected to the depicted networks. Note also that servers 120 and 140 may not have or require a direct Internet connection, but may instead communicate solely via their respective carrier network 115 or LAN 135. And each of the depicted networks usually includes a large number of interconnected components, which for clarity are represented by clouds in FIG. 1.

In accordance with this embodiment of the present invention, when a user of first computer 110 composes an email, either immediately or at some later time, the user may designate that automatic-reply messages to that email are not desired. In some though not all embodiments, certain emails are so designated automatically when pre-determined conditions are met. In either case, an email manager in either the first computer 110 or the first email server 115, or both, monitors incoming email for automatic reply messages to a designated email and deletes or otherwise disposes of them upon detection.

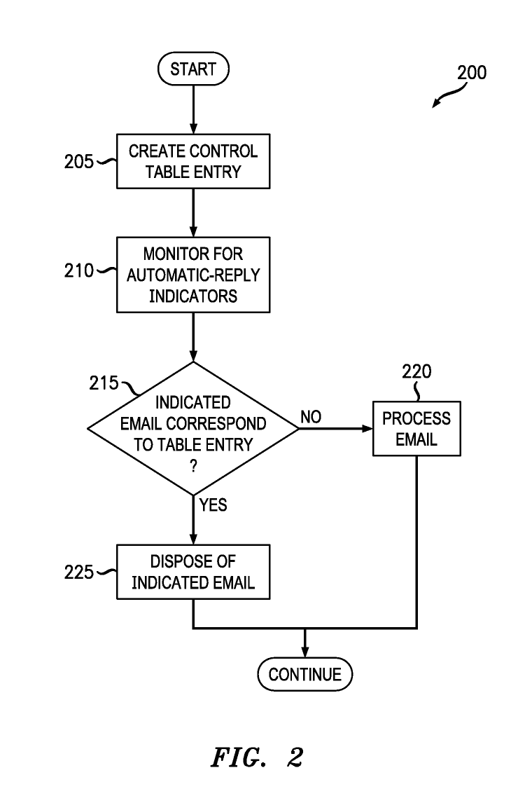

In this manner, embodiments of the present invention alleviate completely or at least partially a need for the user to manually view and delete each out-of-office or other automatic replies to a selected (designated) email, while at the same time permitting all other automatic-reply messages to be seen (unless they related to other emails designated by the user). A method for performing the present invention will now described with reference to FIG. 2.

FIG. 2 is a flow diagram illustrating a method 200 of managing email according to an embodiment of the present invention. At START, it is presumed that the hardware and software have been properly configured and are operational according to the illustrated embodiment. The process then begins when an automatic reply control table entry is created (step 205). As mentioned above, this entry corresponds to an email specifically designated by a user, or in some cases automatically designated upon the occurrence of certain pre-determined events. An email manager then monitors received emails (step 210) to identify any that contain an automatic reply indicator. Received emails that include one or more automatic reply indicators are compared with the automatic reply control table to determine (step 215) if an email so indicated corresponds to an entry. If not, the received email is processed normally (step 220). If an indicted email does correspond to a automatic reply control table entry, then it is automatically deleted or otherwise disposed of (step 225).

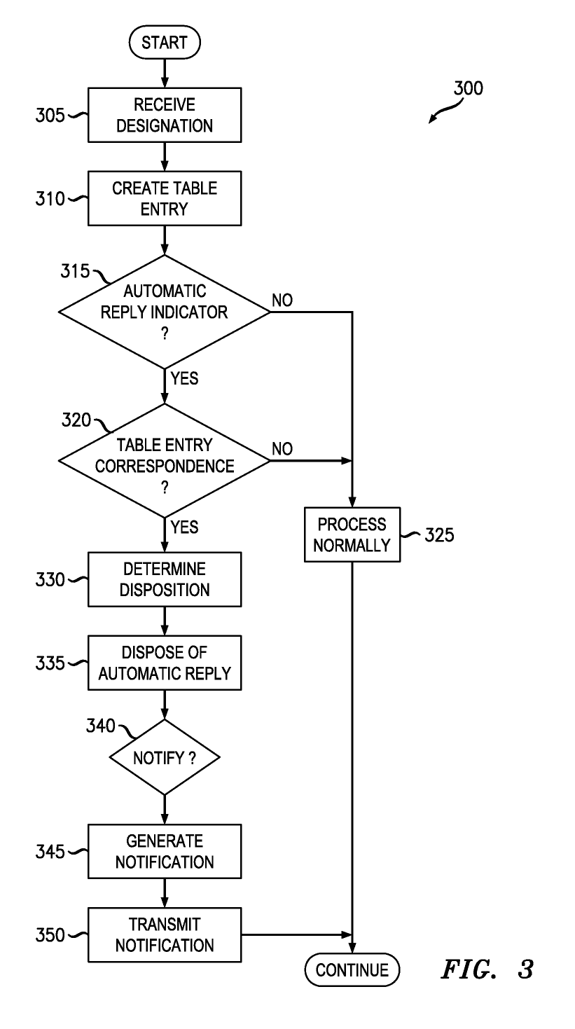

Many variations of this process are possible without deviating from the spirit of the invention. A more detailed process will now be described in reference to FIG. 3. FIG. 3 is a flow diagram illustrating a method 300 of managing email according to another embodiment of the present invention. At START, it is again presumed that the hardware and software have been properly configured and are operational according to this embodiment. The process then begins when the email system receives a designation that automatic-reply messages with respect to a given email message should be controlled (step 305). In most cases this designation will originate with an input made by a user, although in some cases it may be automatically generated upon the occurrence of a pre-determined event.

In this regard it is noted that in some email systems, a user can indicate an email is to be sent (perhaps by “clicking” on a “send” button on their display) well before the email is actually transmitted. The computer may only transmit periodically, for example, or may at that moment not be connected to a network at all. In some systems, then email is designated as being in an “outbox”, and may be further modified or re-addressed before it is transmitted toward its destination over a network. For clarity, this disclosure will indicate that a user “sends” an email—indicates it should be sent—but that an email “is transmitted” when it is actually transmitted from a device, for example a computer or email server, onto a communication network.

In a preferred embodiment, the designation is received at the email manager when the email is actually transmitted from the computer or email server, even though the user makes the designation prior to sending the email. The designation may be made, for example, by clicking on an appropriate button in an email composition window, or selecting from a pull-down window. But it may also be made in response to a query from the email manager after the message it sent. And after the message is sent, or even after it is transmitted, the user may be permitted to select for designation emails from a “sent” email list if one is available.

In any event, when the email manager receives an automatic-reply control message in step 305, it places an entry (step 310) on an automatic-reply control table corresponding to the email. The table entry preferably includes a timestamp corresponding to the time at which the email was transmitted or the contents of the subject line of the email, or both. What is needed, of course, is some way to identify accurately the automatic-reply messages that have been sent in response to a specific (designated) email being transmitted. In some embodiments, it may also include a disposition preference, if such preferences are permitted and indicated. The disposition preference may, for example, be selected from a pull down menu in a composition window.

In some embodiments, entries may remain indefinitely on the automatic reply control list, although this is not preferred. Rather, entries on the list should be deleted (not shown) after a certain amount of time has passed since their creation.

As mentioned above, it is common for automatic reply messages to include in their subject line the contents of the subject line of the originally transmitted message, often with text such as “Out of Office” either prefixed or appended. Other emails may include an annotation such as “auto-reply” or “automatic reply” instead, or in some cases “undeliverable”. For simplicity, all of these will be referred to herein as automatic-reply indicators that are present in the subject line. In some embodiments, the user (or network administrator) is allowed to configure which words or terms are to be considered automatic-reply message indicators. In other embodiments, a vendor may facilitate periodic updates to the automatic-reply message indicator list.

After the email has been transmitted, the subject line of each incoming email is monitored (step 315) for the presence of an automatic-reply indicator. Here it should be noted that these automatic-reply indicators are uncommon for use otherwise, though their use by the original sender should not be unexpected. In one embodiment (not shown), if an automatic-reply indicator is present in the subject line contents section of the automatic-reply control list, the email manager confirms that a second automatic-reply indicator is also present in the subject line of a received email before determining that it is an automatic-reply message.

If a received email does not contain an automatic-reply indicator, it is processed normally (step 325). In most cases, this simply means placing the email in an “inbox” on the email server for future downloading to a computer or on the computer itself, depending on where the method is being executed. If, on the other hand, an automatic-reply indicator is present, the contents of the subject line or other identifying criteria are compared with criteria on the automatic-reply control table (step 320). If no entry on the table corresponds to the received email, then again it may be processed normally (step 325). If, however, the subject line of the received email has identifying characteristics that correspond with an entry in the automatic-reply control table, an appropriate disposition is determined (step 330).

In many embodiments, appropriate disposition will simply be to delete the received automatic reply message. In others, however, it may mean that the detected automatic reply mail is filed in separate folder for optional viewing by the recipient (that is, the original sender of the email). In some cases, the messages are simply tagged or identified in some other fashion, although this is not presently preferred as it does very little to mitigate the technical problem being solved by the present invention.

The disposition with respect to a particular automatic reply message corresponding to a table entry may be indicated in the table itself, and may reflect a user selection previously made. In some embodiments, this selection may be changed (although such a change may not affect those automatic reply messages already received and disposed of. In other embodiments, the disposition may be determined based on the type of automatic reply message indicator that is present, or on a code previously inserted (as explained below).

Once the appropriate disposition is determined, then the received automatic reply message is disposed of (step 335) accordingly. In this embodiment, the email manager then determines (step 340) whether a notification should be generated. This again may be based on either a designation previously made by the user or upon predetermined criteria. In some embodiments, a notification will always be sent, at least as a default, while in others no notifications are generated. If a notification is required, then a notification message is generated (step 345) and transmitted (step 350) to the appropriate recipients. In most cases this will be only the original email sender, but in other cases could include the intended recipient or some other addressee specified by the sender or a network administrator.

If generated, the notification could take the form of a separate message, generated by the disposing node (usually the user's computer or email server). It could also be, however, a pop-up window generated for presentation to the original sender. The message could be triggered by the disposing of a single automatic reply or after a threshold number of automatic replies has been disposed of. The notification itself may simply note the fate of the disposed of emails, or provide a hyperlink to the folder where they have been sent.

After the appropriate notification has been transmitted, or if it is determined at step 340 that no notification is required, then the process continues with the monitoring and processing of any additional messages.

The above described methods are intended to be exemplary and not limiting, and variations are possible without deviating from the scope of the invention. Additional operations may be added, for example, or in some cases removed. And the sequence of operations may be varied in any logically-consistent manner unless a specific sequence is explicitly recited in a particular embodiment.

In another embodiment (not shown), an automatic-reply control code may be added to the subject line of an email sent by a user who has selected the auto-disposing feature for that email. For example, the first three letters of the sender's name followed by “-xr”. Note however, that this can only help ensure that the subject line is unique; in and of itself it is not an automatic reply indicator. It may be used, however, to indicate to the computer or an email server that an auto-disposing feature has been selected. Standard variations could be used in some cases. For example, using “-xr00” to indicate that any automatic reply will simply be deleted and “-xr01” to indicate it will be sent to a junk email folder.

Automatic-reply control codes in the subject line of an outgoing email system could be used, for example, to indicate unambiguously to the (first) email server that any automatic replies to the email being transmitted are to be disposed of. The email server may keep its own automatic-reply control table for this purpose so that the automatic replies are disposed of before being downloaded to the first computer. This also may enable the email server to dispose of the automatic replies before a user accesses them via a Web site access method.

Automatic-reply control codes also enable the recipient (second) email server or second computer to prevent the sending of automatic replies to emails so designated. This also works to alleviate the technical problem being solved, but of course requires that the second computer or second email server, or both, are complying with a pre-established coding system.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method for managing automatic reply messages in an email system, comprising:
creating an entry in an automatic-reply control table associated with a transmitted email if the transmitted email has been designated for automatic reply control;
monitoring each received email for the presence of automatic reply indicators;
determining whether a received email having an automatic reply indicator corresponds with an automatic reply control table entry; and
disposing of the email if it is determined to correspond with an automatic reply control table entry.

2. The method according to claim 1, wherein the transmitted email designation is made by user indication.

3. The method according to claim 1, further comprising determining how the email corresponding to an automatic reply control table entry should be disposed of.

4. The method according to claim 3, wherein the disposition determination is based on an entry in the automatic reply control table.

5. The method according to claim 1, wherein the automatic reply indicators for which received email messages are monitored are user selectable.

6. The method according to claim 1, wherein the entry in the automatic reply control table includes the contents of the subject matter line of the transmitted email.

7. The method according to claim 1, wherein the entry in the automatic reply control table includes a timestamp indicating when the transmitted email was transmitted.

8. The method according to claim 7, further comprising deleting the entry after it has been present on the automatic reply control table for a predetermined period of time.

9. The method according to claim 1, further comprising determining whether a notification message should be generated.

10. The method according to claim 1, further comprising generating a notification message indicating where disposed of automatic-reply messages may be found.
